(19) United States
(12) Patent Application Publication
(10) Pub. No.: US 2022/0136707 A1
(43) Pub. Date: May 5, 2022

(54) EXHAUST DEVICE

(71) Applicant: LG Electronics Inc., Seoul (KR)

(72) Inventors: Youngsoo SON, Seoul (KR); Wontae KIM, Seoul (KR)

(21) Appl. No.: 17/429,779

(22) PCT Filed: Feb. 11, 2020
(86) PCT No.: PCT/KR2020/001914

§ 371 Date: Aug. 10, 2021

(30) Foreign Application Priority Data
Feb. 20, 2019 (KR) 10-2019-0020046

(51) Int. Cl. F24C 15/20; F24F 13/12

(52) U.S. Cl. CPC F24C 15/2021; F24F 13/12; F24C 15/2064; F24C 15/2035

(57) ABSTRACT

The present disclosure relates to an exhaust device. The exhaust gas according to the present disclosure includes a base plate and a swirler. The base plate includes a swirler installation part, an auxiliary intake part, a suction port opened in the swirler installation part, and an auxiliary suction port opened in the auxiliary intake part. In this case, air flows through the base plate via the suction port and the auxiliary suction port.

### TECHNICAL FIELD

The present disclosure relates to an exhaust device.

### BACKGROUND

In general, an exhaust device is a device that suctions polluted air. Accordingly, the exhaust device is used in factories, homes, restaurants, and the like, where a lot of pollutants are generated. In particular, the exhaust device may be installed in the kitchen of the home to suction polluted air generated during cooking.

In relation to such an exhaust device, the present applicant has applied for Prior Art Document 1.
<Prior Art Document 1>
1. Publication No. 10-2016-0163512 (published on Jun. 12, 2018)
2. Title of the Invention: Cooking Appliance and Exhaust Device

Prior Art Document 1 discloses an exhaust device including a swirler for forming a vortex and a grill member for covering the swirler. The grill member is provided with an intake passage corresponding to the swirler, and air flows into the suction passage by the operation of the swirler.

Prior Art Document 1, the intake passage is formed to correspond to the swirler. Accordingly, there is a problem in that a shape of a suction port introduced into the suction passage is limited. In detail, there is a problem in that the amount of flowing air is relatively small because the suction port is formed to correspond to the swirler.

There is a problem in that exhaust efficiency is relatively poor because the amount of flowing air is small. That is, there is a problem in that it takes more time to remove polluted air and user inconvenience may be caused.

### DISCLOSURE

### Technical Problem

The present disclosure has been proposed to solve these problems, and aims to provide an exhaust device including a suction port positioned to correspond to a swirler and an auxiliary suction port positioned spaced apart from the swirler, thereby increasing exhaust efficiency.

In addition, the present disclosure aims to provide an exhaust device in which auxiliary intake parts formed with auxiliary suction ports are disposed in the same shape on both sides of a swirler installation part formed with the suction ports, such that air is stably suctioned.

### Technical Solution

An exhaust device according to the concept of the present disclosure includes a base plate, a swirler rotatably coupled to the base plate, and a driving motor installed in the base plate to provide power for rotating the swirler.

The base plate includes a swirler installation part recessed to accommodate the swirler, an auxiliary intake part spaced apart from the swirler installation part so as to be positioned on at least one side of the swirler installation part, a suction port opened in the swirler installation part so as to be positioned to correspond to the swirler, and an auxiliary suction port opened in the auxiliary intake part so as to be spaced apart from the swirler.

When the swirler is rotated by the operation of the driving motor, air flows through the base plate via the suction port and the auxiliary suction port.

The auxiliary intake part includes a first auxiliary intake part and a second auxiliary intake part respectively formed on both sides of the swirler installation part. The first auxiliary intake part and the second auxiliary intake part may be formed in the same shape.

The swirler installation part may be formed in a shape different from shapes of the first auxiliary intake part and the second auxiliary intake part. The first auxiliary intake part, the swirler installation part, and the second auxiliary intake part may be disposed spaced apart from each other in sequence in a first direction.

### Advantageous Effects

The exhaust device having the above-described configuration according to the embodiment of the present disclosure has the following effects.

As the area of the suction port through which the air passes through the base plate by the swirler is formed to be wider, the amount of flowing air is increased, and thus exhaust efficiency is increased.

Accordingly, the polluted air may be removed within a relatively short time, which increases user convenience.

In addition, as the suction port and the auxiliary suction port are respectively formed in different shapes and disposed spaced apart from each other, the space is used efficiently and the flow of air may not be interrupted.

### BRIEF DESCRIPTION OF DRAWINGS

FIG. 1 is a view showing a space in which an exhaust device according to an embodiment of the present disclosure is installed.

FIG. 2 is a view showing the exhaust device according to an embodiment of the present disclosure.

FIG. 3 is a view taken along line of FIG. 2.

FIG. 4 is a view showing a base plate of the exhaust device according to an embodiment of the present disclosure.

FIG. 5 is an enlarged view of portion ‘A’ of FIG. 4.

### BEST MODE FOR CARRYING OUT THE INVENTION

Hereinafter, some embodiments of the present disclosure will be described in detail with reference to exemplary drawings. It should be noted that when components in the drawings are designated by reference numerals, the same components have the same reference numerals as far as possible even though the components are illustrated in different drawings. Further, in description of embodiments of the present disclosure, when it is determined that detailed descriptions of well-known configurations or functions disturb understanding of the embodiments of the present disclosure, the detailed descriptions will be omitted.

Also, in the description of the embodiments of the present disclosure, the terms such as first, second, A, B, (a) and (b) may be used. These terms are only for distinguishing one component from another, and the nature, order, or sequence of the components is not limited by the terms. When it is described that an element is “coupled to”, “engaged with”, or “connected to” another element, it should be understood that the element may be directly coupled or connected to the other element but still another element may be “coupled to”, “engaged with”, or “connected to” the other element between them.

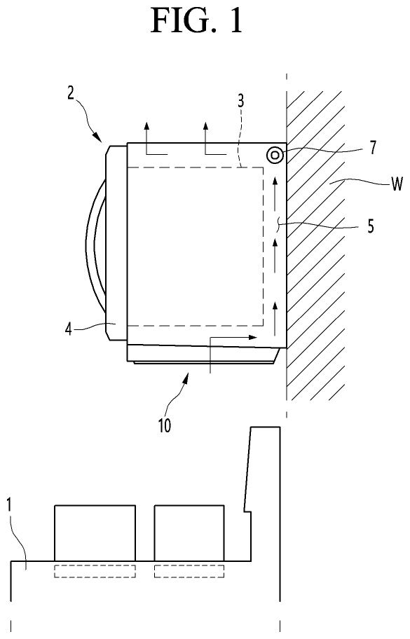

FIG. 1 is a view showing a space in which an exhaust device according to an embodiment of the present disclosure is installed.

As shown in FIG. 1, the exhaust device 10 according to the concept of the present disclosure may be installed in a kitchen. In particular, the exhaust device 10 may be disposed above a first cooking appliance 1 in which a user cooks a predetermined food. For example, the first cooking appliance 1 may include a gas range.

Accordingly, the exhaust device 10 may suction and discharge polluted air generated when the first cooking appliance 1 is used. In addition, the exhaust device 10 may be coupled to a second cooking appliance 2 installed on a wall W of the kitchen. For example, the second cooking appliance 2 may include a wall-mounted microwave oven.

The second cooking appliance 2 may include a cooking space 3 accommodating food and an air passage 5 communicating with the exhaust device 10. In addition, the second cooking appliance 2 may further include a door 4 configured to open or close the cooking space 3 and a fan 7 installed in the air passage 5.

In this case, the cooking space 3 and the air passage 5 are provided as separate spaces. That is, the cooking operation of the second cooking appliance 2 and the exhaust operation of the exhaust device 10 may be separately performed.

Referring to an arrow shown in FIG. 1, the air suctioned upward by the exhaust device 10 flows along the air passage 5. The air flows along the air passage 5 and may be discharged to one side. In addition, the air passage 5 may be disposed to communicate with an exhaust hole formed in the wall, such that the polluted air may be discharged to the outside.

In this case, the first cooking appliance and the second cooking appliance are merely exemplary. Accordingly, the exhaust device 10 may be installed in various forms at a required place. In addition, of course, only the exhaust device 10 may be installed alone.

Hereinafter, the exhaust device 10 will be described in detail.

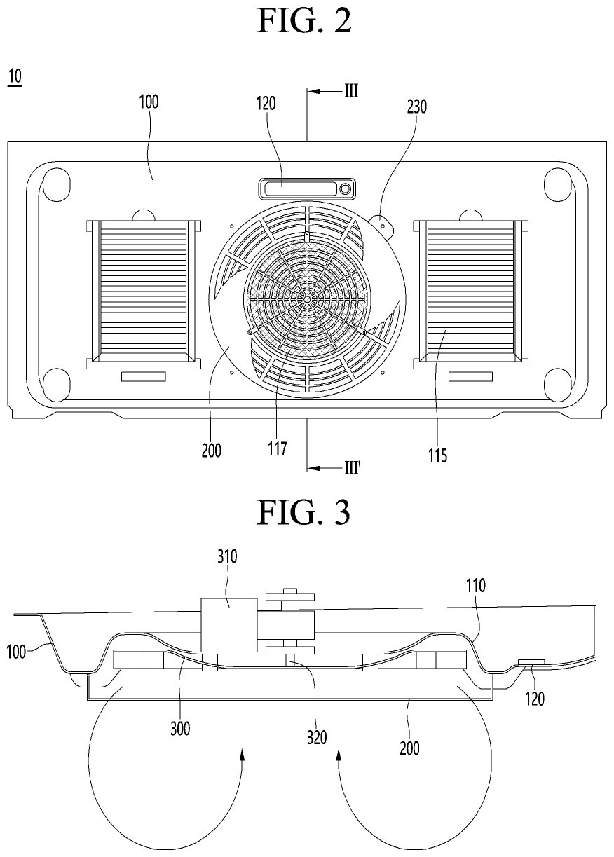

FIG. 2 is a view showing the exhaust device according to an embodiment of the present disclosure, and FIG. 3 is a view taken along line of FIG. 2.

As shown in FIGS. 2 and 3, the exhaust device 10 includes a base plate 100 and a swirler 300. The base plate 100 forms the outer appearance of the exhaust device 10 and may be understood as a configuration in which the swirler 300 is installed.

The swirler 300 is rotatably installed to form the flow of air. That is, the swirler 300 may be rotatably coupled to the base plate 100. In detail, a rotation shaft 320 of the swirler 300 is installed to pass through the base plate 100.

The rotation shaft 320 may be rotated by being coupled to a driving motor 310 configured to provide a driving force. At this time, the driving motor 310 and the swirler 300 are respectively installed on opposite surfaces of the base plate 100.

In addition, the exhaust device 10 includes a filter bracket 200 that is detachably coupled to the base plate 100. In detail, the filter bracket 200 may be understood as a configuration for protecting the swirler 300.

Accordingly, the filter bracket 200 is coupled to the base plate 100 to cover the swirler 300. As shown in FIG. 2, the swirler 300 is not exposed to the outside by the filter bracket 200. Referring to FIG. 3, the swirler 300 is disposed between the filter bracket 200 and the base plate 100.

The filter bracket 200 may be provided in a circular flat plate as a whole. The filter bracket 200 has various openings and irregularities.

In this case, the bait plate 100 and the filter bracket 200 may be made of different materials and manufactured through different processes. For example, the base plate 100 may be made of steel, and the filter bracket 200 may be made of plastic. In addition, the base plate 100 may be formed on a predetermined flat plate through a machining process, and the filter bracket 200 may be formed through an injection process.

At this time, the filter bracket 200 corresponds to a configuration in which the air flowing by the swirler 300 primarily contacts. That is, there is a relatively high possibility that pollutants are accumulated in the filter bracket 200. Accordingly, the user needs to periodically clean the filter bracket 200.

The exhaust device 1 according to the concept of the present disclosure has a structure in which the filter bracket 200 is easily separated from the base plate 100 for user convenience. In detail, the filter bracket 200 may be fitted to the base plate 100.

For example, the filter bracket 200 may be provided with a protruding rib (not shown) protruding toward the base plate 100. The protruding rib may be fitted to the base plate 100, and the filter bracket 200 may be installed in the base plate 100.

In addition, the filter bracket 200 is provided with a fastening rib 230 coupled to the base plate 100 through a fastening member. The fastening rib 230 may be understood as an auxiliary coupling part for fitting. Accordingly, the fastening ribs 230 may be provided in a minimum number. For example, the fastening rib 230 may be provided as one fastening rib.

In addition, the exhaust device 10 is provided with filters 115 and 117 through which the air flowing by the swirler 300 passes. In particular, the filters 115 and 117 may correspond to filters configured to filter oil in flowing air. The filters include a first filter 117 installed at one side of the swirler 300 and a second filter 115 installed at an auxiliary intake part 130 to be described later.

The first filter 117 is installed in the filter bracket 200 to filter the air flowing into the swirler 300. In particular, the first filter 117 may be formed in a circular shape and installed in the central portion of the filter bracket 200.

In addition, a lighting 120 may be installed in the base plate 100. For example, the lighting 120 may be installed to irradiate the first cooking appliance 1 with light. Accordingly, a user may conveniently cook food in the first cooking appliance 1.

Hereinafter, the base plate 100 will be described in detail.

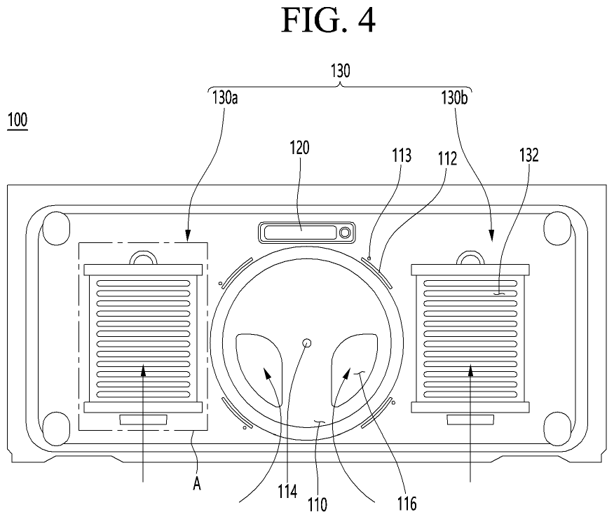

FIG. 4 is a view showing the base plate of the exhaust device according to an embodiment of the present disclosure. The filter bracket 200, the swirler 300, and the filters 115 and 117 of FIG. 2 are omitted in FIG. 4 in order to describe the base plate 100.

As shown in FIG. 4, the base plate 100 may be provided as a rectangular flat plate. The base plate 100 has various openings and irregularities through various processing processes.

The base plate 100 is provided with a swirler installation part 110 recessed such that the swirler 300 is accommodated therein. The swirler installation part 110 is formed in a circular shape to correspond to the shape of the swirler 300. A rotation hole 114 through which the rotation shaft 320 of the swirler 300 passes is formed in the central portion of the swirler installation part 110.

That is, the swirler installation part 110 may be understood as a circular recessed part formed around the rotation hole 114. In addition, the swirler installation part 110 is formed in a circular shape greater than the swirler 300 so as not to interfere with the rotation of the swirler 300. In addition, the rotation shaft 320 is installed to pass through the rotation hole 114.

In addition, the swirler installation part 110 is provided to guide the flow of air. Referring to the flow of air indicated by the arrow in FIG. 3, it can be seen that the flow of air is formed along the swirler installation part 110. In detail, as the swirler 300 is rotated, the flow of air is formed from the edge of the swirler installation part 110 to the center side.

At this time, the filter bracket 200 is coupled to the base plate 100 to cover the swirler installation part 110. In detail, the base plate 100 includes a slit 112 that is opened such that at least a portion of the filter bracket 200 is inserted thereinto.

As shown in FIG. 4, the slit 112 is opened in an arc shape having a predetermined curvature. In particular, the slit 112 may correspond to an arc of a virtual circle formed around the rotation hole 114. At this time, the virtual circle has a larger diameter than the swirler installation part 110.

In addition, the slit 112 is formed in plurality. For example, as shown in FIG. 4, four slits 112 may be provided. The slits 112 are provided with the same size and shape, and are spaced apart from each other at equal intervals in a circumferential direction. In this case, the number of slits 112 is exemplary.

In addition, the base plate 100 includes a fastening hole 113 that is opened. The fastening hole 113 corresponds to an opening into which a predetermined fastening member passing through the filter bracket 200 is inserted. That is, the fastening hole 113 may be understood as an opening coupled to the fastening rib 230 of the filter bracket 200 by the fastening member.

In this case, the fastening hole 113 is radially spaced apart from the slit 112. In detail, the fastening hole 113 is formed outside the slit 112. That is, the fastening hole 113 is formed outside the swirler installation part 110, and the slit 112 is disposed closer to the rotation hole 114 than the fastening hole 113.

In other words, the rotation hole 114, the slit 112, and the fastening hole 113 are sequentially disposed in one direction. In this case, one direction corresponds to the radially outer side of the circle formed around the rotation hole 114.

In addition, the fastening hole 113 is formed in plurality. For example, as shown in FIG. 4, four fastening holes 113 may be provided. The fastening holes 113 are provided with the same size and shape, and are spaced apart from each other at equal intervals in a circumferential direction. In this case, the number of fastening holes 113 is exemplary.

In addition, the slit 112 and the fastening hole 113 may be provided in the same number. This is for convenience of coupling with the filter bracket 200 to be described later. A coupling protrusion 113 protruding rearward may be formed on the rear surface of the frame light guide 112.

In this case, both the slit 112 and the fastening hole 113 correspond to an opening for coupling with the filter bracket 200. However, the filter bracket 200 is inserted into the slit 112, and the fastening member coupled to the filter bracket 200 is inserted into the fastening hole 113. That is, it can be seen that the filter bracket 200 is fitted through the slit 112 and fixed through the fastening hole 113.

In addition, the base plate 100 includes a suction port 116 that is opened in the swirler installation part 110. That is, the suction port 116 is positioned to correspond to the swirler 300. Accordingly, the suction port 116 corresponds to an opening through which air is suctioned through the base plate 100 by the flow of air shown in FIG. 3.

The shape and number of suction ports 116 may be provided differently depending on the design. As shown in FIG. 4, the suction port 116 may be provided as a pair of openings symmetrical about the rotation hole 114. In addition, the driving motor 310 may be installed between the pair of suction ports 116.

In this case, the suction port 116 may be formed only at the rear of the swirler installation part 110. In detail, in FIG. 4, the upper portion of the swirler installation part 110 corresponds to the front, and the lower portion of the swirler installation part 110 corresponds to the rear. Such a structure is to efficiently form a vortex by the swirler 300.

As such, since the suction port 116 is formed only at one side of the swirler installation part 110, the area through which the air flows is relatively small. That is, there is a problem in that a flow rate of air passing through the base plate 100 is small, and thus exhaust may not be performed faster.

Therefore, the exhaust device 10 according to the present disclosure is provided with an auxiliary intake part 130 for solving such a problem. In other words, the base plate 100 includes the auxiliary intake part 130 formed at one side of the swirler installation part 110.

As shown in FIG. 4, the auxiliary intake part 130 may be spaced apart from one side of the swirler installation part 110. In addition, the auxiliary intake part 130 is provided with an auxiliary suction port 132 that is opened. That is, the auxiliary suction port 132 is positioned spaced apart from the swirler 300.

As indicated by an arrow in FIG. 4, the flow of air is generated not only through the suction port 116 but also through the auxiliary suction port 132. That is, when the swirler 300 is rotated by the operation of the driving motor 310, air flows through the base plate 100 through the suction port 116 and the auxiliary suction port 132.

Accordingly, a larger amount of air may flow into the exhaust device 10. That is, since the polluted air may be suctioned and exhausted more quickly, user convenience is increased.

In addition, the auxiliary intake part 130 includes a first auxiliary intake part 130a and a second auxiliary intake part 130b respectively formed on both sides of the swirler installation part 110. At this time, the first auxiliary intake part 130a and the second auxiliary intake part 130b are formed in the same shape. It may be understood that this is for forming a stable air flow.

In addition, the first auxiliary intake part 130a, the swirler installation part 110, and the second auxiliary intake part 130b are sequentially spaced apart from each other in a first direction. In this case, the first direction means any one direction, and may correspond to a horizontal direction in FIG. 4. That is, the first auxiliary intake part 130a, the swirler installation part 110, and the second auxiliary intake part 130b are arranged in parallel in one direction.

In this case, the lighting 120 is disposed spaced apart from the swirler installation part 110 in a second direction perpendicular to the first direction. In this case, the second direction means any one direction perpendicular to the first direction, and may correspond to a vertical direction in FIG. 4.

In particular, the lighting 120 may be disposed in front of the swirler installation part 110. As described above, the front corresponds to a direction in which the suction port 116 is not formed in the swirler installation part 110.

In addition, the swirler installation part 110 is formed in a shape different from that of the first auxiliary intake part 130a and the second auxiliary intake part 130b. In detail, the swirler installation part 110 is formed in a circular shape, and the first and second auxiliary intake parts 130a and 130b are formed in a rectangular shape.

For example, the first and second auxiliary intake parts 130a and 130b may be formed in a rectangular shape having a long side corresponding to a diameter of the swirler installation part 110. Accordingly, the swirler installation part 110 and the first and second auxiliary intake parts 130a and 130b may have the same length in the second direction and may be arranged in parallel in the first direction.

As described above, a circular first filter 117 is installed in the filter bracket 200 that covers the swirler installation part 110. It may be understood that the first filter 117 is installed in the filter bracket 200 to filter the air flowing into the suction port 116.

The second filter 115 is installed in the first and second auxiliary intake parts 130a and 130b to filter the air flowing into the auxiliary suction port 132. In this case, the second filter 115 is provided in a shape different from that of the first filter 117. In detail, the second filter 115 may be provided in a rectangular shape corresponding to the first and second auxiliary intake parts 130a and 130b.

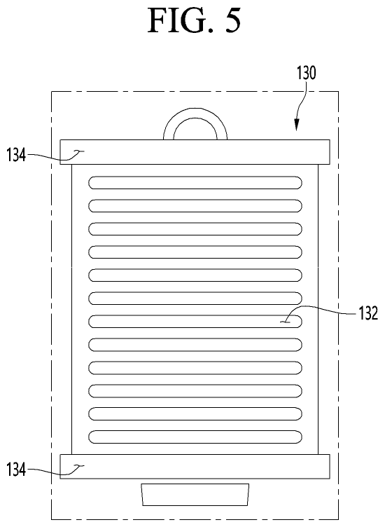

FIG. 5 is a view illustrating a portion ‘A’ of FIG. 4. FIG. 5 is a view showing the first auxiliary intake part 130a of the base plate 100. As described above, the first and second auxiliary intake parts 130a and 130b are formed in the same shape. Accordingly, the first auxiliary intake part 130a is referred to as the auxiliary intake part 130, and the description of the second auxiliary intake part 130b is omitted.

As shown in FIG. 5, the auxiliary intake part 130 includes a pair of filter seating grooves 134 that are opened such that the second filter 115 is seated thereon. In detail, the pair of filter seating grooves 134 are opened as long grooves extending in the first direction.

In addition, the pair of filter seating grooves 134 are spaced apart from each other in the second direction perpendicular to the first direction. Accordingly, both ends of the second filter 115 may be fitted and coupled to the filter seating grooves 134, respectively.

The auxiliary suction port 132 is opened to extend in one direction in the auxiliary intake part 130. In particular, the auxiliary suction port 132 is opened in a shape of a long groove extending in the first direction. In addition, the auxiliary suction port 132 may be provided in plurality that are spaced apart from each other in the second direction.

In particular, the auxiliary suction port 132 may be formed between the pair of filter seating grooves 134. That is, the auxiliary suction port 132 and the pair of filter seating grooves 134 are sequentially spaced apart from each other in the second direction. In detail, the filter seating groove 134, the plurality of auxiliary suction ports 132, and the filter seating groove 134 are arranged in this order in the second direction.

In this case, the filter seating groove 134 may be opened with a larger area than that of the auxiliary suction port 132. Referring to FIG. 5, one filter seating groove 134 is formed to extend further in the first direction and the second direction than the one auxiliary suction port 132.

By forming the auxiliary suction port 132 as described above, the flow rate of the air flowing into the exhaust device 10 may be increased. That is, the exhaust efficiency of the exhaust device 10 may be increased.

1. An exhaust device comprising:
a base plate;
a swirler rotatably coupled to the base plate; and
a driving motor installed in the base plate to provide power for rotating the swirler,
wherein the base plate comprises:
a swirler installation part recessed to accommodate the swirler;
an auxiliary intake part spaced apart from the swirler installation part so as to be positioned on at least one side of the swirler installation part;
a suction port opened in the swirler installation part so as to be positioned to correspond to the swirler; and
an auxiliary suction port opened in the auxiliary intake part so as to be spaced apart from the swirler, and
wherein, when the swirler is rotated by the operation of the driving motor, air flows through the base plate via the suction port and the auxiliary suction port.

2. The exhaust device of claim 1, wherein the auxiliary intake part comprises a first auxiliary intake part and a second auxiliary intake part respectively formed on both sides of the swirler installation part, and
wherein the first auxiliary intake part and the second auxiliary intake part are formed in the same shape.

3. The exhaust device of claim 2, wherein the swirler installation part is formed in a shape different from shapes of the first auxiliary intake part and the second auxiliary intake part, and
wherein the first auxiliary intake part, the swirler installation part, and the second auxiliary intake part are disposed spaced apart from each other in sequence in a first direction.

4. The exhaust device of claim 3, wherein the auxiliary suction port is opened in the first auxiliary suction port and the second auxiliary suction port in a shape of a long groove extending in the first direction.

5. The exhaust device of claim 3, wherein the base plate further comprises a lighting disposed spaced apart from the swirler installation part in a second direction perpendicular to the first direction.

6. The exhaust device of claim 5, wherein the auxiliary suction port is formed with a plurality of auxiliary suction ports opened by extending in the first direction in the first auxiliary suction port and the second auxiliary suction port and disposed spaced apart from each other in the second direction.

7. The exhaust device of claim 1, further comprising a filter bracket coupled to the base plate to cover the swirler installation part,
wherein the swirler is disposed between the filter bracket and the base plate.

8. The exhaust device of claim 7, further comprising:
a first filter installed in the filter bracket to filter air flowing into the suction port; and
a second filter installed in the auxiliary intake part to filter air flowing into the auxiliary suction port.

9. The exhaust device of claim 8, wherein the auxiliary intake part is provided with a pair of filter seating grooves opened such that the second filter are seated therein, and
wherein the auxiliary suction port is formed between the pair of filter seating grooves.

10. The exhaust device of claim 9, wherein the pair of filter seating grooves and the auxiliary suction port are opened in a shape of a long groove extending in a first direction in the auxiliary intake part,
wherein the pair of filter seating grooves are disposed spaced apart from each other in a second direction perpendicular to the first direction, and
wherein the auxiliary suction port is provided with a plurality of auxiliary suction ports spaced apart from each other in the second direction.

11. The exhaust device of claim 9, wherein the filter seating groove is opened with a larger area than that of the auxiliary suction port.

12. The exhaust device of claim 8, wherein the first filter and the second filter are formed in different shapes.

13. The exhaust device of claim 1, further comprising a rotation shaft coupled to the central portion of the swirler to transmit power of the driving motor to the swirler,
wherein the base plate further comprises a rotation hole through which the rotation shaft is installed.

14. The exhaust device of claim 13, wherein the swirler installation part is recessed in a circular shape in the base plate,
wherein the rotation hole is formed in the central portion of the swirler installation part.

15. The exhaust device of claim 14, wherein the auxiliary intake part is formed in a rectangular shape on both sides of the swirler installation part, and
wherein the auxiliary suction port is formed as a long groove extending in one direction in the auxiliary intake part.
